(19) United States
(12) Patent Application Publication
(10) Pub. No.: US 2021/0400244 A1
(43) Pub. Date: Dec. 23, 2021

(54) OPTICAL SCANNING TYPE VIDEO PROJECTION DEVICE

(71) Applicant: University of Fukui, Fukui-shi, (JP)

(72) Inventors: Toshio Katsuyama, Fukui-shi (JP); Shoji Yamada, Fukui-shi (JP); Akira Nakao, Fukui-shi (JP)

(73) Assignee: University of Fukui, Fukui-shi (JP)

(21) Appl. No.: 17/464,118

(22) Filed: Sep. 1, 2021

Related U.S. Application Data
(63) Continuation of application No. PCT/JP2020/049253, filed on Dec. 28, 2020.

(30) Foreign Application Priority Data
Feb. 20, 2020 (JP) 2020-027609

(51) Int. Cl. H04N 9/31; G02B 6/12; G02B 26/10

(52) U.S. Cl. CPC H04N 9/3161; H04N 9/3129; G02B 26/105; G02B 6/12007

(57) ABSTRACT

The present invention relates to an optical scanning type video projection device that decreases the height of the optical scanning type video projection device by improving the disposition of a light source module device and an optical scanning mirror device. The optical scanning type video projection device has: a first substrate on which an optical waveguide type multiplexer having a plurality of optical waveguides and a light multiplexer is provided; a second substrate on which an optical scanning mirror device having a movable mirror is provided; and an optical member configured to guide a light beam emitted from the optical waveguide type multiplexer to the movable mirror in a direction that is different from an emitting direction of the light beam. The first substrate and the second substrate are disposed in parallel with each other.

### CROSS-REFERENCE TO RELATED APPLICATION

This application is a continuation application of International Application Number PCT/JP2020/049253 filed on Dec. 28, 2020, now pending, herein incorporated by reference. Further, this application is based upon and claims the benefit of priority from the prior Japanese Patent Application No. 2020-027609, filed on Feb. 20, 2020, entire contents of which are incorporated herein by reference.

### FIELD

The present invention relates to an optical scanning type video projection device, and more particularly to, for example, a disposing structure in which a light source module device and an optical scanning mirror device are disposed and which decreases the height of the optical scanning type video projection device.

### BACKGROUND

Various optical beam projection devices are known as devices that scan with a light beam, such as a laser beam, in two directions orthogonal to each other. A two-dimensional optical scanning type video projection device constituted of a light source module device and an optical scanning mirror device is based on a system where the light source module device multiplexes three primary colors, i.e., red, blue, green, of laser light rays into one laser beam using a lens and a mirror, however a problem is that downsizing of the optical beam projection device is difficult (see Patent Literature 1 and Patent Literature 2 for example).

On the other hand, in a case of a two-dimensional optical scanning type video projection device constituted of a three primary color light source module device, in which a semiconductor laser and an optical waveguide type multiplexer are combined; and an optical scanning mirror device, downsizing and power reduction of the device are possible, and this two-dimensional optical scanning type video projection device is applied to a laser beam scanning type color image projection device (see Patent Literature 3 for example).

FIG. 32 is a two-dimensional optical scanning type video projection device proposed by the present inventor. A three primary color light source module device 140 is constituted of a combination of a red semiconductor laser chip 147, a green semiconductor laser chip 148, a blue semiconductor laser chip 149, and an optical waveguide type multiplexer 143. A light beam emitted from the three primary color light source module device 140 is radiated to a scanning mirror 131 of a two-dimensional optical scanning mirror device 130. The scanning mirror 131 two-dimensionally scans with the entered light beam by using a solenoid coil 132. The reference numbers 120 and 121 indicate mounting substrates.

### CITATION LIST

### Patent Literature

Patent Literature 1: Japanese Patent No. 4856758
Patent Literature 2: Japanese Patent No. 5281923
Patent Literature 3: WO2015/170505

### Non-Patent Literature

Non Patent Literature 1: Journal of Radio Engineering & Electronics Association: FORN-2019.7, No. 329, pp. 36-39

In a case of the two-dimensional optical scanning type video projection device (optical engine) constituted of: the three primary color light source module device, in which the semiconductor laser and the optical waveguide type multiplexer are combined; and the two-dimensional optical scanning mirror drive, the dimensions of the two-dimensional optical scanning type video projection device need to be minimized for commercial application. In this case, the width and length of the two-dimensional optical scanning type video projection device need to be small, but in the case of applying this device to a spectacle display, in particular, not only the width and length but also the height of the video projection device need to be decreased.

For example, in the case of Non Patent Literature 1, the light beam emitted from the three primary color light source module device, in which the semiconductor laser and the optical waveguide type multiplexer are combined, is applied to a scanning mirror of the two-dimensional optical scanning mirror device to reflect the light beam, therefore the two-dimensional optical scanning mirror device need to be installed in a tilted state, as illustrated in FIG. 32. This means that the height of the two-dimensional optical scanning type video projection device increases by the amount of tilting of the optical scanning mirror device, which is a shortcoming.

It is an object of the present invention to decrease the height of the optical scanning type video projection device by improving the disposition of the light source module device and the optical scanning mirror device in the optical scanning type video projection device.

### SUMMARY

According to one embodiment, an optical scanning type video projection device includes: a first substrate on which an optical waveguide type multiplexer having a plurality of optical waveguides and an optical multiplexing unit is provided; a second substrate on which an optical scanning mirror device having a movable mirror is provided; and an optical member configured to guide a light beam emitted from the optical waveguide type multiplexer to the movable mirror in a direction that is different from an emitting direction of the light beam, wherein the first substrate and the second substrate are disposed in parallel with each other.

As one aspect of the optical scanning type video projection device, the height of the optical scanning type video projection device can be decreased by improving the disposition of the light source module device and the optical scanning mirror device in the optical scanning type projection device.

### BRIEF DESCRIPTION OF DRAWINGS

FIG. 1 is a schematic configuration diagram of the two-dimensional optical scanning type video projection device of the embodiment of the present invention.

FIG. 2 is a perspective view of a key portion of the two-dimensional optical scanning type video projection device of the embodiment of the present invention.

FIG. 3 is a schematic configuration diagram of the two-dimensional optical scanning type video projection device of embodiment 1 of the present invention.

FIG. 4 is a perspective view of a key portion of the two-dimensional optical scanning type projection device of embodiment 1 of the present invention.

FIG. 5 is an explanatory diagram of an optical scanning state in the two-dimensional optical scanning type video projection device of embodiment 1 of the present invention.

FIG. 6 is a schematic configuration diagram of the two-dimensional optical scanning type video projection device of embodiment 2 of the present invention.

FIG. 7 is an explanatory diagram of an optical scanning state in the two-dimensional optical scanning type video projection device of embodiment 2 of the present invention.

FIG. 8 is a schematic configuration diagram of the two-dimensional optical scanning type video projection device of embodiment 3 of the present invention.

FIG. 9 is a schematic configuration diagram of the two-dimensional optical scanning type video projection device of embodiment 4 of the present invention.

FIG. 10 is a perspective view of a key portion of the two-dimensional optical scanning type video projection device of embodiment 5 of the present invention.

FIG. 11 is an explanatory diagram of an optical scanning state in the two-dimensional optical scanning type video projection device of embodiment 5 of the present invention.

FIG. 12 is a schematic configuration diagram of the two-dimensional optical scanning type video projection device of embodiment 6 of the present invention.

FIG. 13 is a schematic configuration diagram of the two-dimensional optical scanning type video projection device of embodiment 7 of the present invention.

FIG. 14 is a schematic configuration diagram of the two-dimensional optical scanning type video projection device of embodiment 8 of the present invention.

FIG. 15 is a schematic configuration diagram of the two-dimensional optical scanning type video projection device of embodiment 9 of the present invention.

FIG. 16 is a schematic configuration diagram of the two-dimensional optical scanning type video projection device of embodiment 10 of the present invention.

FIG. 17 is a schematic configuration diagram of the two-dimensional optical scanning type video projection device of embodiment 11 of the present invention.

FIG. 18 is a schematic configuration diagram of the two-dimensional optical scanning type video projection device of embodiment 12 of the present invention.

FIG. 19 is a schematic configuration diagram of the two-dimensional optical scanning type video projection device of embodiment 13 of the present invention.

FIG. 20 is an explanatory diagram of a reflection state in the two-dimensional optical scanning type video projection device of embodiment 13 of the present invention.

FIG. 21 is an explanatory diagram of the two-dimensional optical scanning type video projection device of embodiment 14 of the present invention.

FIG. 22 is an explanatory diagram of a key portion of the two-dimensional optical scanning type video projection device of embodiment 15 of the present invention.

FIG. 23 is an explanatory diagram of a key portion of the two-dimensional optical scanning type video projection device of embodiment 16 of the present invention.

FIG. 24 is an explanatory diagram of a key portion of the two-dimensional optical scanning type video projection device of embodiment 17 of the present invention.

FIG. 25 is a schematic configuration diagram of the two-dimensional optical scanning type video projection device of embodiment 18 of the present invention.

FIG. 26 is a schematic configuration diagram of the two-dimensional optical scanning type video projection device of embodiment 19 of the present invention.

FIG. 27 is a schematic configuration diagram of the two-dimensional optical scanning type video projection device of embodiment 20 of the present invention.

FIG. 28 is a schematic configuration diagram of the two-dimensional optical scanning type video projection device of embodiment 21 of the present invention.

FIG. 29 is a schematic configuration diagram of the two-dimensional optical scanning type video projection device of embodiment 22 of the present invention.

FIG. 30 is a schematic configuration diagram of the two-dimensional optical scanning type video projection device of embodiment 23 of the present invention.

FIG. 31 is a schematic configuration diagram of the two-dimensional optical scanning type video projection device of embodiment 24 of the present invention.

FIG. 32 is a two-dimensional optical scanning type video projection device proposed by the present inventor.

### DESCRIPTION OF EMBODIMENTS

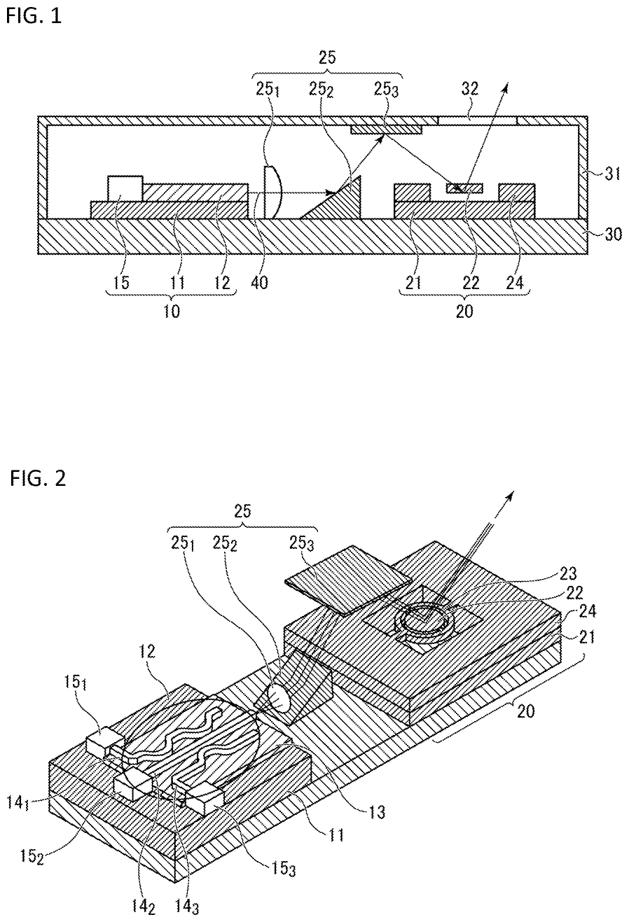

A two-dimensional optical scanning type video projection device of an embodiment of the present invention will be described with reference to FIG. 1 and FIG. 2. FIG. 1 is a schematic configuration diagram of the two-dimensional optical scanning type video projection device of the embodiment of the present invention, and FIG. 2 is a perspective view of a key portion of the two-dimensional optical scanning type video projection device of the embodiment of the present invention. This two-dimensional optical scanning type video projection device includes: a light source module device substrate 11 (a first substrate), on which an optical waveguide type multiplexer 12 including a plurality of optical waveguide patterns 14 and an optical multiplexing unit is disposed; a two-dimensional optical scanning mirror device substrate 21 (a second substrate) on which a two-dimensional optical scanning mirror device 20 including a movable mirror 22 is disposed; and an optical member 25 which guides the light beam emitted from the optical waveguide type multiplexer 12 in a direction different from an emitting direction of the light beam and to the movable mirror 22. Here the optical waveguide type multiplexer 12 and light source elements 15 at each incident end of a plurality of optical waveguide patterns 14 are disposed, whereby a light source module device 10 is constituted. In an embodiment of the present invention, the light source module substrate 11 and the two-dimensional optical scanning mirror device substrate 21 are disposed in positions which are in parallel with each other.

In the two-dimensional optical scanning mirror device 20, a movable outer frame member 23 is provided inside a non-movable outer frame member 24 via a hinge, and the movable mirror 22 is provided inside the movable outer frame member 23 via a hinge. In this case, it is preferable that a main surface of the movable mirror 22 is in parallel with a main surface of the two-dimensional optical scanning mirror device substrate 21 in a non-operation state, thereby the height of the two-dimensional optical scanning type video projection device can be decreased. The driving principle of the two-dimensional optical scanning mirror device 20 here is piezoelectric driving based on the piezoelectric effect, but an electrostatic driving type or electromagnetic driving type driving device may be used.

This two-dimensional optical scanning type video projection device normally includes a common mounting substrate 30, on which the light source module device substrate 11 and the two-dimensional optical scanning mirror device substrate 21 are mounted. The mounting surface of the mounting substrate 30 is flat as a whole, and for the optical components 25, a first reflection mirror (25₂) and a second reflection mirror (25₃), which guides an output multiplexed light beam 40 reflected by the first reflection mirror (25₂) to the movable mirror 22, may be disposed on the mounting substrate 30. In this case, the second reflection mirror (25₃) may be disposed on a ceiling surface of a cover member, that is, at a position facing the mounting surface of the mounting substrate 30.

One of the first reflection mirror (25₂) and the second reflection mirror (25₃) may be a light condensing reflection mirror. In a case where the first reflection mirror (25₂) is a non-light condensing reflection mirror, a condensing lens (25₁) may be disposed between the optical waveguide type multiplexer 12 and the first reflection mirror (25₂). Further, for the optical component 25, a prism member (25₆), which has a plurality of reflection surfaces to reflect the output multiplexed light beam 40, may be used.

For the mounting substrate 30, a step type substrate, which has a step between the mounting surface of the light source module device substrate 11 and the mounting surface of the two-dimensional optical scanning mirror device substrate 21, may be used, and in this case, the mounting surface of the two-dimensional optical scanning mirror device substrate 21 may be the lower step side. Here for the optical members 25, a condensing lens 25₁ and a non-light condensing reflection mirror (25₇) may be used, or a light condensing reflection mirror (25₈) may be used.

The two-dimensional optical scanning mirror device 20 may be disposed on the ceiling surface of the covering member, that is, at a position facing the mounting surface of the mounting substrate 30. In this case, for the optical members 25, the condensing lens 25₁ and the non-light condensing reflection mirror 25₂ may be used, or a light condensing reflection mirror 25₅ may be used. Further, a reflection mirror 26 that reflects the reflected light from the movable mirror 22 may be disposed on the mounting substrate 30, or in the case of not disposing the reflection mirror 26, a window (35), which the reflected light from the movable mirror 22 transmits through, may be disposed on the mounting substrate 30.

A cover member 31, that covers the light source module device 10 and the two-dimensional optical scanning mirror device 20, is disposed on the two-dimensional optical scanning type video projection device. This cover member 31 may be divided into a first cover member (31₁) that covers the light source module device 10, and a second cover member (31₂) that covers the two-dimensional optical scanning mirror device 20.

The light source elements 15 in this case are typically a blue semiconductor laser 15₁, a green semiconductor laser 15₂, and a red semiconductor laser 15₃, but may be a light-emitting diode (LED) or a light source connected via an optical fiber or a spherical lensed optical fiber, and in the case of using an optical fiber or a spherical lensed optical fiber, a liquid laser or a solid-state laser may be used for the light source thereof.

For the light source module device substrate 11 and the two-dimensional optical scanning mirror device substrate 21, an Si substrate, a glass substrate, a sapphire substrate, a plastic substrate, or the like may be used. In the case of forming the optical waveguide patterns 14₁ to 14₃, an optical waveguide forming layer 13, which is a lower clad layer, may be formed on the light source module device substrate 11, a material to be a core layer is disposed thereon, and this core layer is etched. An upper core layer may be formed thereon. For a material of the optical waveguide forming layer 13, the core layer and the upper clad layer, An SiO₂ glass material may be used, but other materials, such as transparent plastic (e.g. acrylic resin) and other transparent materials, may be used. In the case where light source elements each having wavelength other than RGB are used for the light source elements 15, such a semiconductor material as Si an GaN may be used for the core layer and the clad layer. The structure of the optical multiplexing portion is arbitrary, but here the optical multiplexing unit disclosed in Patent Literature 1 is used.

By the above configuration, the height of the two-dimensional optical scanning type video projection device can be decreased, thereby when the video projection device is stored in the portion of the temple of the spectacle frame of the spectacle type display, the thickness of the temple can be decreased, that is, the two-dimensional optical scanning type video projection device can be stored inconspicuously.

When the two-dimensional optical scanning type video projection device is packaged, wire bonding need to be used to connect the wires for the light source module device 10 and the two-dimensional optical scanning mirror device 20, which are components thereof, with pads. In this embodiment of the present invention, the light source module device substrate 11, on which the optical waveguide type multiplexer 12 is disposed, and the two-dimensional optical scanning mirror device substrate 21, on which the two-dimensional optical scanning mirror device 20 including the movable mirror 22 is disposed, are disposed in parallel with each other, therefore the wire bonding need not be performed separately, but can be performed simultaneously using a wire bonding device, and as a result, wiring is easy and fabrication cost can be reduced.

### Embodiment 1

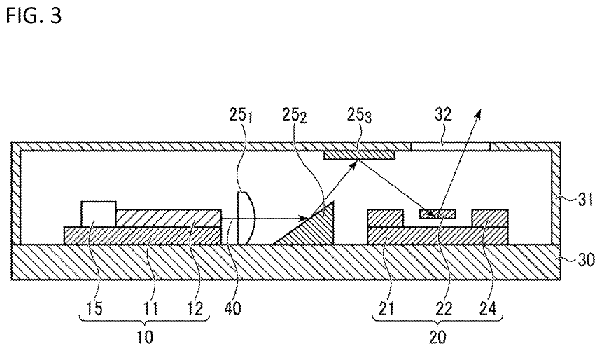

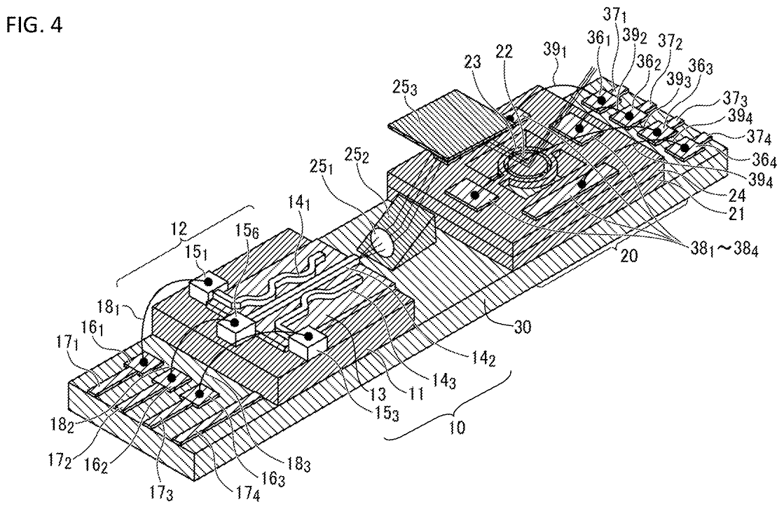

A two-dimensional optical scanning type video projection device of embodiment 1 of the present invention will be described with reference to FIG. 3 to FIG. 5. FIG. 3 is a schematic configuration diagram of the two-dimensional optical scanning type video projection device of embodiment 1 of the present invention, FIG. 4 is a perspective view of a key portion of the two-dimensional optical scanning type projection device of embodiment 1 of the present invention, and FIG. 5 is an explanatory diagram of an optical scanning state in the two-dimensional optical scanning type video projection device of embodiment 1 of the present invention. As illustrated in FIG. 3, in the two-dimensional optical scanning type video projection device of embodiment 1 of the present invention, the light source module device substrate 11 on which the optical waveguide type multiplexer 12 including the three optical waveguide patterns 14 and the optical multiplexing unit is disposed; and the two-dimensional optical scanning mirror device substrate 21, on which the piezoelectric drive type two-dimensional optical scanning mirror device 20 including the movable mirror 22 is disposed, are mounted on the common mounting substrate 30. For the optical waveguide type multiplexer 12, a type of optical waveguide type multiplexer disclosed in Patent Literature 3 is used.

Here the chip size of the light source module device 10 is 6 mm (length)×4 mm (width)×1 mm (height). Specifically, a 15 μm thick SiO₂ film, to be the optical waveguide forming layer 13, is formed by flame hydrolysis on the light source module device substrate 11 formed of a 1 mm thick Si substrate. Then on the SiO₂ film, a 2 μm thick SiO₂—GeO₂ layer (refractive index difference Δn=0.5%, defined by Δn=(n₁−n₂)/n₁. n₁: refractive index of core and n₂: refractive index of clad) is formed by flame hydrolysis. Then on this layer, the optical waveguide patterns 14₁ to 14₃, of which waveguide width is 2 μm, are formed by an optical exposure method using a contact mark. Thereby the optical multiplexer is formed.

Then on the optical waveguide patterns 14₁ to 14₃, a 20 μm thick SiO₂ film (not illustrated), which is an upper clad layer, is formed by flame hydrolysis as a cover layer which covers the entire optical waveguide patterns 14₁ to 14₃. For the optical waveguide pattern 14₁ for blue and the optical waveguide pattern 14₃ for red, light incident portions thereof need to be bent at a right angle, therefore a 30 μm deep trench is formed in each bending portion by Ga-based etching using a converged ion beam method, so that the guided light is totally reflected by the side wall of the trench. Then, leaving only the region of the optical multiplexer, the entire SiO₂ film on the other portion is removed by etching, so that the light source module device substrate 11 is exposed. Thereby the optical waveguide type multiplexer 12 is formed.

The blue semiconductor laser 15₁, the green semiconductor laser 15₂, and the red semiconductor laser 15₃ are disposed at the edges of the optical waveguide patterns 14₁ to 14₃ of the optical waveguide type multiplexer 12. Thereby the light source module device 10 is formed. At this time, the light source module device substrate 11 formed of the Si substrate is etched to a predetermined depth, so as to match the positions of the laser-emitting ends of the blue semiconductor laser 15₁, a green semiconductor laser 15₂, and a red semiconductor laser 15₃ and the positions of the optical waveguide patterns 14₁ to 14₃.

On the other hand, the two-dimensional optical scanning mirror device 20, of which dimensions are 7 mm (length)×5 mm (width)×0.7 mm (height), is formed by performing a MEMS processing on an Si wafer. This two-dimensional optical scanning mirror device 20 is constituted of the movable mirror 22, the movable outer frame member 23, and the non-movable outer frame member 24. The size of the movable mirror 22 is 1 mm φ, and an aluminum (Al) film is formed on the surface. The reflectance of the movable mirror 22 is 90% or more for all of red, green and blue.

A piezoelectric material film, such as PZT, is formed on the surface of the non-movable outer frame member 24, and pads (38₁ to 38₄) for piezoelectric driving are formed. By applying a drive voltage, of which high-speed (horizontal) axis drive frequency is 35 KHz, low-speed (vertical) axis drive frequency is 60 Hz and maximum drive voltage is ±15V, to the pads (38₁ to 38₄) for piezoelectric driving, the movable mirror 22 is rotated in the horizontal direction and the vertical direction at the same time. At this time, the high-speed (horizontal) axis swing angle (mirror deflection angle) is ±15°, for example, and the low-speed (vertical) axis swing angle (mirror deflection angle) is ±15°, for example.

The embodiment 1 of the present invention includes: the condensing lens 25₁ that converges an emission multiplexed light beam 40 which is emitted from the optical waveguide type multiplexer 12; the non-light condensing reflection mirror 25₂ which bends the emission multiplexed light beam 40 upward at least once; and the non-light condensing reflection mirror 25₃ that reflects the emission multiplexed light beam 40, which was bended up by the non-light condensing reflection mirror 25₂ toward the movable mirror 22.

Here for the condensing lens 25₁, a combination lens of a convex lens and a concave lens is used for example, and the thickness thereof is 0.7 mm and the focal distance is 1.35 mm, for example. For the non-light condensing reflection mirror 25₂, a quartz glass on which surface an Al film is formed is used, and the angle of the reflection surface of the non-light condensing reflection mirror 25₂ from the mounting surface of the mounting substrate 30 is 8°, for example, and the size of the reflection surface is 5 mm (length)×3 mm (width). For the non-light condensing reflection mirror 25₃, a quartz glass on which surface an Al film is formed is used, and the angle of the reflection surface of the non-light condensing reflection mirror 25₃ from the mounting surface of the mounting substrate 30 is 24°, for example, and the size of the reflection surface is 1.2 mm (length)×1.2 mm (width).

The cover member 31 having a window 32 to cover the light source module device 10 and the two-dimensional optical scanning mirror device 20 is disposed on the two-dimensional optical scanning type video projection device. This cover member 31 is normally formed of a light-shielding metal member, such as Al, of which thickness is 0.5 mm, but may be formed of an insulating member instead. The emission multiplexed light beam 40 reflected by the non-light condensing reflection mirror 25₃ emits through the window 32 after two-dimensionally scanned by the movable mirror 22, and projects video onto a screen or a retina.

As illustrated in FIG. 4, the light source module device 10 and the two-dimensional optical scanning mirror device 20 are die-bonded onto the common mounting substrate 30, and pads 16₁ to 16₃ and wires on substrate 17₁ to 17₄ are disposed on one side of the edges of the mounting substrate 30. The blue semiconductor laser 15₁, the green semiconductor laser 15₂ and the red semiconductor laser 15₃ are connected to the pads 16₁ to 16₃ via bonding wires 18₁ to 18₃ so as to be energizable. The pads 36₁ to 36₄ and wires on substrate 37₁ to 37₄ are disposed on the other side of the edges of the mounting substrate 30. Pads 38₁ to 38₄ disposed on the surface of the non-movable outer frame member 24 are connected to the pads 36₁ to 36₃ via bonding wires 39₁ to 39₄ so as to be energizable.

Since the light source module device 10 and the two-dimensional optical scanning mirror device 20 have already been disposed in parallel on the common mounting substrate 30, the wire bonding at this time can be performed virtually under the same bonding conditions, without changing the direction of bonding, for example. As a result, wires are formed easily and fabrication cost can be reduced.

As illustrated in FIG. 5, the emission multiplexed light beam 40, which is emitted from the optical waveguide type multiplexer 12, is converged by the condensing lens 25₁, is then bended upward by the non-light condensing reflection mirror 25₂, and is reflected toward the movable mirror 22 by the non-light condensing reflection mirror 25₃. The reflected emission multiplexed light beam 40 emits through the window 32 after two-dimensionally scanned by the movable mirror 22, and projects video onto a screen or a retina.

In FIG. 5, a reflected light beam 41 indicates a case where the angle of the movable mirror is 0°, a reflected light beam 42 indicates a case where the angle of the movable mirror 22 is tilted by 12°, and a reflected light beam 43 indicates a case where the angle of the movable mirror 22 is tilted by 12° in the opposite direction.

As described above, according to embodiment 1 of the present invention, the first substrate 11 of the light source module device 10 and the two-dimensional optical scanning mirror device substrate 21 of the two-dimensional optical scanning mirror device 20 are disposed in parallel on the common mounting substrate 30, hence wire bonding is performed easily. Further, when the two-dimensional optical scanning type video projection device is packaged with the cover member 31, the thickness of an internal space between the surface of the mounting substrate 30 and the ceiling surface of the cover member 31 is extremely thin, about 3 mm, that is, a thin packaging of which height is very low can be implemented.

### Embodiment 2

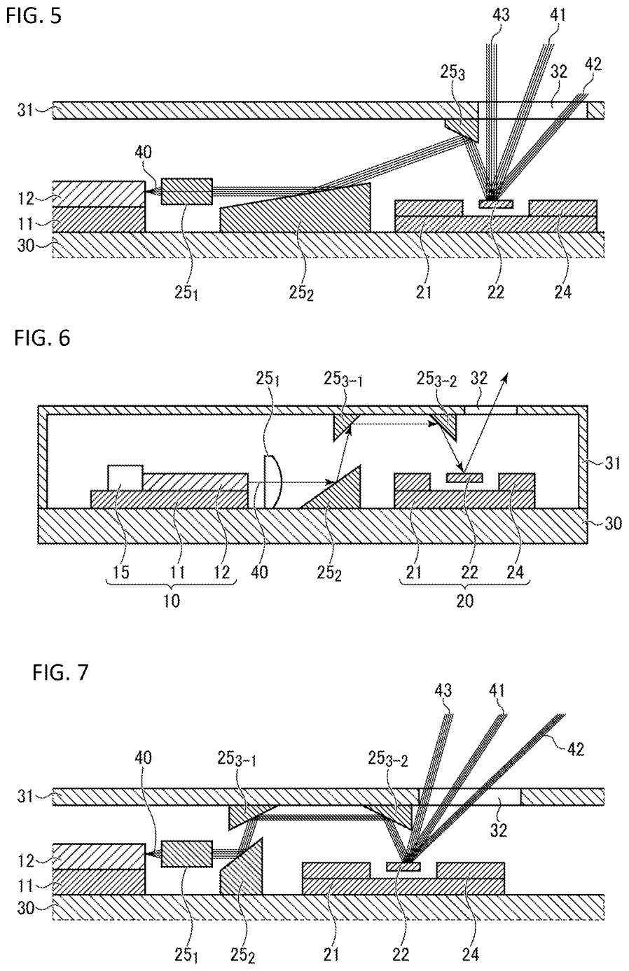

A two-dimensional optical scanning type video projection device of embodiment 2 of the present invention will be described with reference to FIG. 6 and FIG. 7. FIG. 6 is a schematic configuration diagram of the two-dimensional optical scanning type video projection device of embodiment 2 of the present invention, and FIG. 7 is an explanatory diagram of an optical scanning state in the two-dimensional optical scanning type video projection device of embodiment 2 of the present invention. As illustrated in FIG. 6, in the two-dimensional optical scanning type video projection device of embodiment 2 of the present invention, the optical waveguide type multiplexer 12, including the three optical waveguide patterns 14 and the optical multiplexing unit in the two-dimensional optical scanning type video projection device of embodiment 1, is disposed on the light source module device substrate 11; and the piezoelectric drive type two-dimensional optical scanning mirror device 20, including the movable mirror 22, is disposed on the two-dimensional optical scanning mirror device substrate 21. These two substrates are mounted on the common mounting substrate 30. For the optical waveguide type multiplexer 12, the optical waveguide type multiplexer disclosed in Patent Literature 3 is used.

As illustrated in FIG. 7, in embodiment 2 of the present invention, the non-light condensing reflection mirror 25₃ in embodiment 1 is divided into non-light condensing reflection mirrors 25₃₋₁ and 25₃₋₂. The emission multiplexed light beam 40, which is emitted from the optical waveguide type multiplexer 12, is converged by the condensing lens 25₁, and is then bended upward by the non-light condensing reflection mirror 25₂, and is reflected toward the movable mirror 22 by the non-light condensing reflection mirrors 25₃₋₁ and 25₃₋₂. The reflected emission multiplexed light beam 40 emits through the window 32 after two-dimensionally scanned by the movable mirror 22, and projects video onto a screen or a retina.

In FIG. 7, the reflected light beam 41 indicates a case where the angle of the movable mirror is 0°, the reflected light beam 42 indicates a case where the angle of the movable mirror 22 is tilted by 12°, and the reflected light beam 43 indicates a case where the angle of the movable mirror 22 is tilted by 12° in the opposite direction.

As described above, according to embodiment 2 of the present invention, the non-light condensing reflection mirror, which is disposed on the ceiling of the cover member 31, is divided into the non-light condensing reflection mirrors 25₃₋₁ and 25₃₋₂, hence the thickness of the internal space between the surface of the mounting substrate 30 and the ceiling surface of the cover member 31 can be about 2 mm, that is, a thinner packaging of which height is even lower can be implemented.

### Embodiment 3

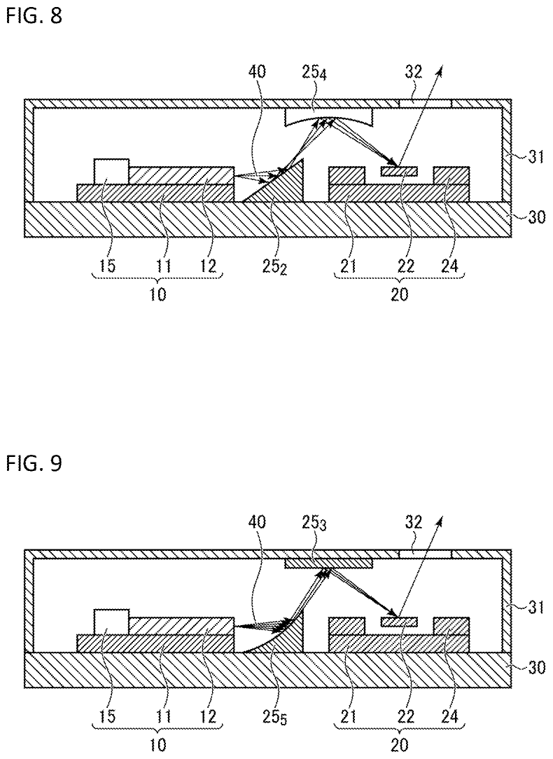

A two-dimensional optical scanning type video projection device of embodiment 3 of the present invention will be described with reference to FIG. 8, where the non-light condensing reflection mirror 25₃ of embodiment 1 is replaced with a light condensing reflection mirror 25₄, so that the condensing lens (25₁) is not needed. FIG. 8 is a schematic configuration diagram of the two-dimensional optical scanning type video projection device of embodiment 3 of the present invention. Here the shape and disposition of each reflection mirror are schematically illustrated, and for the actual shape, refer to embodiment 1 described above.

As illustrated in FIG. 8, in the two-dimensional optical scanning type video projection device of embodiment 3 of the present invention, the optical waveguide type multiplexer 12 including the three optical waveguide patterns 14 and the optical multiplexing unit, is disposed on the light source module device substrate 11; and the piezoelectric drive type two-dimensional optical scanning mirror device 20, including the movable mirror 22, is disposed on the two-dimensional optical scanning mirror device substrate 21. These two substrates are mounted on the common mounting substrate 30. For the optical waveguide type multiplexer 12, the optical waveguide type multiplexer disclosed in Patent Literature 3 is used.

In embodiment 3 of the present invention, the non-light condensing reflection mirror 25₂ is disposed to bend the emission multiplexed light beam 40, which is emitted from the optical waveguide type multiplexer 12, upward, and the light condensing reflection mirror 25₄ is disposed to reflect the emission multiplexed light beam 40, which is bended upward by the non-light condensing reflection mirror 25₂, toward the movable mirror 22 in the converging state. The reflected emission multiplexed light beam 40 emits through the window 32 after two-dimensionally scanned by the movable mirror 22, and projects video onto a screen or a retina.

According to embodiment 3 of the present invention, the light condensing reflection mirror 25₄ is used, hence the condensing lens (25₁) is not needed, and the length of the two-dimensional optical scanning type video projection device can be decreased. The other functional effects are the same as embodiment 1 described above.

### Embodiment 4

A two-dimensional optical scanning type video projection device of embodiment 4 of the present invention will be described with reference to FIG. 9, where the non-light condensing reflection mirror 25₂ of embodiment 1 is replaced with a light condensing reflection mirror 25₅, so that the condensing lens (25₁) is not needed. FIG. 9 is a schematic configuration diagram of the two-dimensional optical scanning type video projection device of embodiment 4 of the present invention. Here the shape and disposition of each reflection mirror are schematically illustrated, and for the actual shape, refer to embodiment 1 described above.

As illustrated in FIG. 9, in the two-dimensional optical scanning type video projection device of embodiment 4 of the present invention, the optical waveguide type multiplexer 12, including the three optical waveguide patterns 14 and the optical multiplexing unit, is disposed on the light source module device substrate 11; and the piezoelectric drive type two-dimensional optical scanning mirror device 20, including the movable mirror 22, is disposed on the two-dimensional optical scanning mirror device substrate 21. These two substrates are mounted on the common mounting substrate 30. For the optical waveguide type multiplexer 12, the optical waveguide type multiplexer disclosed in Patent Literature 3 is used.

In embodiment 4 of the present invention, a light condensing reflection mirror 25₅ is disposed to bend the emission multiplexed light beam 40, which is emitted from the optical waveguide type multiplexer 12, upward, and the emission multiplexed light beam 40 is bended up toward the non-light condensing reflection mirror 25₃ in the condensed state by the light condensing reflection mirror 25₅, and is reflected toward the movable mirror 22 by the non-light condensing reflection mirror 25₃. The reflected emission multiplexed light beam 40 emits through the window 32 after two-dimensionally scanned by the movable mirror 22, and projects video onto a screen or a retina.

According to embodiment 4 of the present invention, the light condensing reflection mirror 25₅ is used, hence the condensing lens (25₁) is not needed, and the length of the two-dimensional optical scanning type video projection device can be decreased. The other functional effects are the same as embodiment 1 described above.

### Embodiment 5

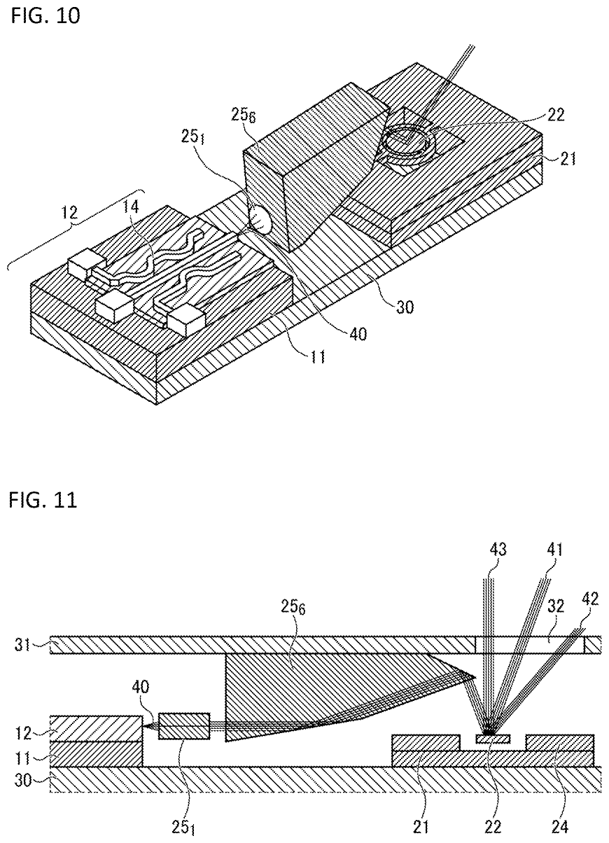

A two-dimensional optical scanning type video projection device of embodiment 5 of the present invention will be described with reference to FIG. 10 and FIG. 11, where a prism having two reflection surfaces is used instead of the two optical members to change the optical paths of the non-light condensing reflection mirrors 25₂ and 25₃, and the like, in embodiment 1. FIG. 10 is a perspective view of a key portion of the two-dimensional optical scanning type video projection device of embodiment 5 of the present invention, and FIG. 11 is an explanatory diagram of an optical scanning state in the two-dimensional optical scanning type video projection device of embodiment 5 of the present invention.

As illustrated in FIG. 10, in the two-dimensional optical scanning type video projection device of embodiment 5 of the present invention, the optical waveguide type multiplexer 12, including the three optical waveguide patterns 14 and the optical multiplexing unit, is disposed on the light source module device substrate 11; and the piezoelectric drive type two-dimensional optical scanning mirror device 20, including the movable mirror 22, is disposed on the two-dimensional optical scanning mirror device substrate 21. These two substrates are mounted on the common mounting substrate 30. For the optical waveguide type multiplexer 12, the optical waveguide type multiplexer disclosed in Patent Literature 3 is used.

In embodiment 5 of the present invention, the prism 25₆ having two reflection surfaces is disposed via the light condensing lens 25₁, to bend the emission multiplexed light beam 40, which is emitted from the optical waveguide type multiplexer 12, upward.

As illustrated in FIG. 11, the emission multiplexed light beam 40, which is emitted from the optical waveguide type multiplexer 12, is converged by the condensing lens 25₁, is then bended upward and is reflected toward the movable mirror 22 by the prism 25₆. The reflected emission multiplexed light beam 40 emits through the window 32 after two-dimensionally scanned by the movable mirror 22, and projects video onto a screen or a retina.

In FIG. 11, the reflected light beam 41 indicates a case where the angle of the movable mirror is 0°, the reflected light beam 42 indicates a case where the angle of the movable mirror 22 is tilted by 12°, and the reflected light beam 43 indicates a case where the angle of the movable mirror 22 is tilted by 12° in the opposite direction. Here the prism 25₆ is fixed to the cover member 31, but may be fixed to the mounting substrate 30.

### Embodiment 6

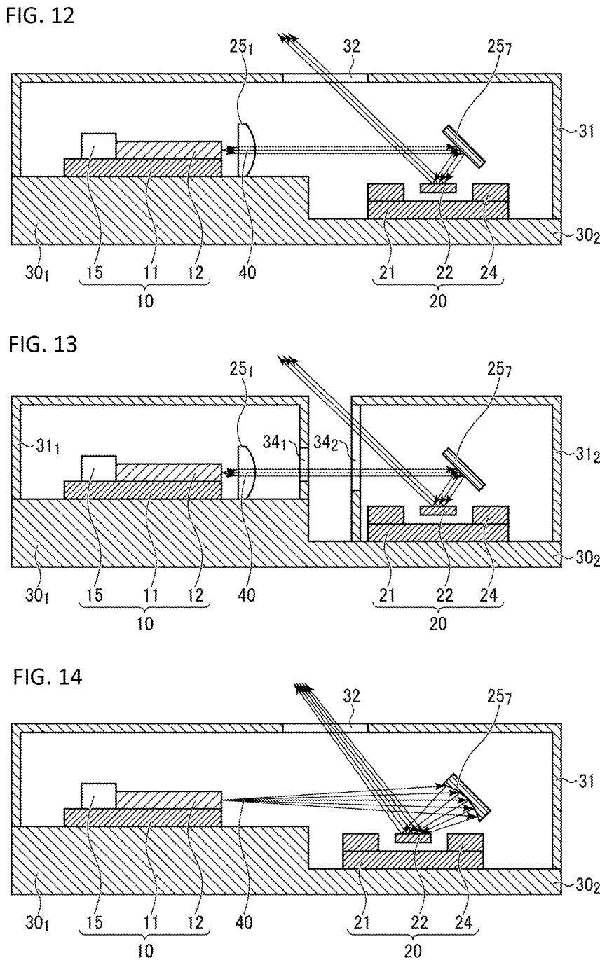

A two-dimensional optical scanning type video projection device of embodiment 6 of the present invention will be described with reference to FIG. 12, where a substrate having a step is used for the mounting substrate of embodiment 1, but a substrate having no step may be used in this configuration. As illustrated in FIG. 12, in the two-dimensional optical scanning type video projection device of embodiment 6 of the present invention, the light source module device substrate 11, on which the optical waveguide type multiplexer 12, including the three optical waveguide patterns 14 and the optical multiplexing unit, is disposed, is mounted on an upper mounting portion 30₁ of the mounting substrate 30, and the piezoelectric drive type two-dimensional optical scanning mirror device 20, including the movable mirror 22, is mounted on a lower mounting portion 30₂ of the mounting substrate 30. For the optical waveguide type multiplexer 12, the optical waveguide type multiplexer disclosed in Patent Literature 3 is used.

According to embodiment 6 of the present invention, the emission multiplexed light beam 40 emitted from the optical waveguide type multiplexer 12 enters the non-light condensing reflection mirror 25₇ in a state of being condensed by the condensing lens 25₁, is reflected by the non-light condensing reflection mirror 25₇, and the reflected emission multiplexed light beam 40 enters the movable mirror 22. The entered emission multiplexed light beam 40 emits through the window 33 after two-dimensionally scanned by the movable mirror 22, and projects video onto a screen or a retina.

According to embodiment 6 of the present invention, the mounting substrate 30 having the step is used, hence the non-light condensing reflection mirrors 25₂ and 25₃, the light condensing reflection mirrors 25₄ and 25₅, and the like are not needed. Since there is no need to consider the disposition of these composing elements, assembly of the two-dimensional optical scanning type video projection device is easy.

### Embodiment 7

A two-dimensional optical scanning type video projection device of embodiment 7 of the present invention will be described with reference to FIG. 13, where the cover member of embodiment 6 is divided into two. As illustrated in FIG. 13, in the two-dimensional optical scanning type video projection device of embodiment 7 of the present invention, the light source module substrate 11, on which the optical waveguide type multiplexer 12, including the three optical waveguide patterns 14 and the optical multiplexing unit, is disposed, is mounted on an upper mounting portion 30₁ of the mounting substrate 30, and the piezoelectric drive type two-dimensional optical scanning mirror device 20, including the movable mirror 22, is mounted on the lower mounting portion 30₂ of the mounting substrate 30. For the optical waveguide type multiplexer 12, the optical waveguide type multiplexer disclosed in Patent Literature 3 is used.

In embodiment 7 of the present invention, the light source module device cover member 31₁ having the window 34₁ to cover the light source module device 10 and the condensing lens 25₁ is disposed, and the two-dimensional optical scanning mirror device cover member 31₂, having the window 34₂ to cover the two-dimensional optical scanning mirror device 20 and the non-light condensing reflection mirror 25₇, is disposed.

According to embodiment 7 of the present invention, the mounting substrate 30 having the step is used, and the cover member 31 is divided into the light source module device cover member 31₁ and the two-dimensional optical scanning mirror device cover member 31₂, hence the cover member 31 can be manufactured easily. The other functional effects are the same as embodiment 6.

### Embodiment 8

A two-dimensional optical scanning type video projection device of embodiment 8 of the present invention will be described with reference to FIG. 14, where the non-light condensing reflection mirror of embodiment 6 is replaced with a light condensing reflection mirror 25₈, so that the condensing lens 25₁ is not needed. As illustrated in FIG. 14, in the two-dimensional optical scanning type video projection device of embodiment 8 of the present invention, the light source module device substrate 11, on which the optical waveguide type multiplexer 12, including the three optical waveguide patterns 14 and the optical multiplexing unit, is disposed, is mounted on the upper mounting portion 30₁ of the mounting substrate 30; and the piezoelectric drive type two-dimensional optical scanning mirror device 20, including the movable mirror 22, is mounted on the lower mounting portion 30₂ of the mounting substrate 30. For the optical waveguide type multiplexer 12, the optical waveguide type multiplexer disclosed in Patent Literature 3 is used.

In embodiment 8 of the present invention, the emission multiplexed light beam 40, which is emitted from the optical waveguide type multiplexer 12, enters the light condensing reflection mirror 25₈, and is reflected by the non-light condensing reflection mirror 25₈ in the condensed state, and this reflected emission multiplexed light beam 40 enters the movable mirror 22. The entered emission multiplexed light beam 40 emits through the window 33 after two-dimensionally scanned by the movable mirror 22, and projects video onto a screen or a retina.

According to embodiment 8 of the present invention, the non-light condensing reflection mirror 25₈ is used, hence the light-condensing lens is not needed, and the length of the two-dimensional optical scanning type video projection device can be decreased. The other functional effects are the same as embodiment 5.

### Embodiment 9

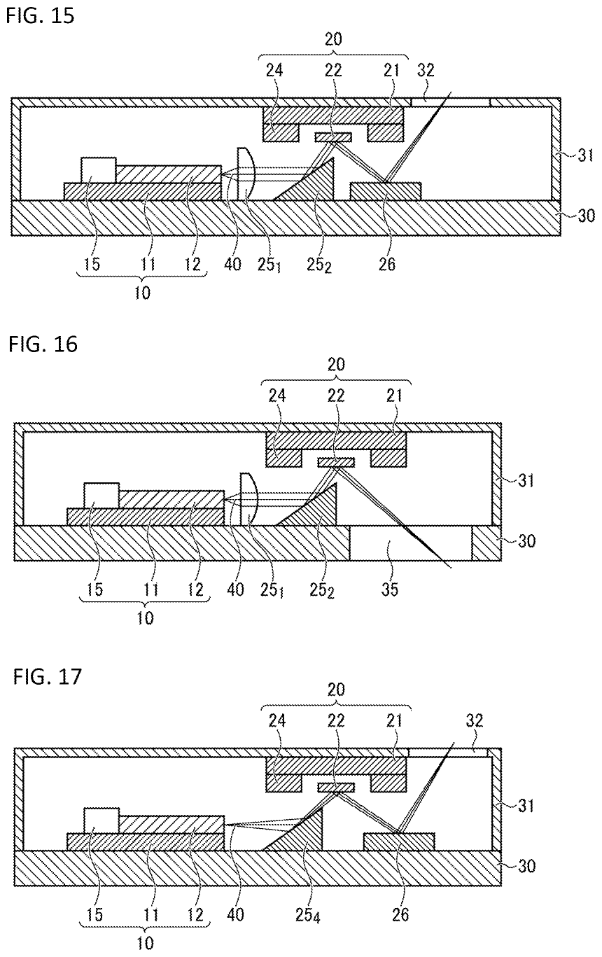

A two-dimensional optical scanning type video projection device of embodiment 9 of the present invention will be described with reference to FIG. 15, where the positional relationship of the two-dimensional optical scanning mirror device 20 and the non-light condensing reflection mirror 25₃ of embodiment 1 is reversed. FIG. 15 is a schematic configuration diagram of the two-dimensional optical scanning type video projection device of embodiment 9 of the present invention. Here the shape and disposition of each reflection mirror are schematically illustrated, and for the actual shape, refer to embodiment 1 described above.

As illustrated in FIG. 15, in the two-dimensional optical scanning type video projection device of embodiment 9 of the present invention, the light source module device substrate 11, on which the optical waveguide type multiplexer 12, including the three optical waveguide patterns 14 and the optical multiplexing unit, is disposed, is mounted on the mounting substrate 30. On the other hand, the two-dimensional optical scanning mirror device substrate 21, on which the piezoelectric drive type two-dimensional optical scanning mirror device 20, including the movable mirror 22, is disposed, is mounted on the ceiling portion of the cover member 31. In this case as well, the light source module device substrate 11 and the two-dimensional optical scanning mirror device substrate 21 are disposed in parallel with each other. For the optical waveguide type multiplexer 12, the optical waveguide type multiplexer disclosed in Patent Literature 3 is used.

In embodiment 9 of the present invention, the non-light condensing reflection mirror 25₂ is disposed to bend the emission multiplexed light beam 40, which is emitted from the optical waveguide type multiplexer 12 and is converged by the condensing lens 25₁, upward, and the emission multiplexed light beam 40, which was bended upward by the non-light condensing reflection mirror 25₂, is emitted toward the movable mirror 22. The emission multiplexed light beam 40 is reflected by the reflection mirror 26 disposed on the mounting substrate 30 after two-dimensionally scanned by the movable mirror 22, then emits through the window 32, and projects video onto a screen or a retina.

According to embodiment 9 of the present invention, the position of the two-dimensional optical scanning mirror device substrate 21 can be shifted toward the optical waveguide type multiplexer 12 side without overlapping with the optical waveguide type multiplexer 12, hence the overall length (“length”) of the two-dimensional optical scanning type video projection device can be decreased. The other functional effects are the same as embodiment 1 described above.

### Embodiment 10

A two-dimensional optical scanning type video projection device of embodiment 10 of the present invention will be described with reference to FIG. 16, where a window 35 is provided in the mounting substrate 30 without providing the reflection mirror 26 of embodiment 9. FIG. 16 is a schematic configuration diagram of the two-dimensional optical scanning type video projection device of embodiment 10 of the present invention. Here the shape and disposition of each reflection mirror are schematically illustrated, and for the actual shape, refer to embodiment 1 described above.

As illustrated in FIG. 16, in the two-dimensional optical scanning type video projection device of embodiment 10 of the present invention, the light source module device substrate 11, on which the optical waveguide type multiplexer 12, including the three optical waveguide patterns 14 and the optical multiplexing unit, is disposed, is mounted on the mounting substrate 30. On the other hand, the two-dimensional optical scanning mirror device substrate 21, on which the piezoelectric drive type two-dimensional optical scanning mirror device 20, including the movable mirror 22, is disposed, is mounted on the ceiling portion of the cover member 31. For the optical waveguide type multiplexer 12, the optical waveguide type multiplexer disclosed in Patent Literature 3 is used.

In embodiment 10 of the present invention, the non-light condensing reflection mirror 25₂ is disposed to bend the emission multiplexed light beam 40, which is emitted from the optical waveguide type multiplexer 12 and is converged by the condensing lens 25₁, upward, and the emission multiplexed light beam 40 which was bended upward by the non-light condensing reflection mirror 25₂ is emitted toward the movable mirror 22. The emission multiplexed light beam 40 emits through the window 35 provided in the mounting substrate 30 after two-dimensionally scanned by the movable mirror 22, and projects video onto a screen or a retina.

According to embodiment 10 of the present invention, the window 35 is provided at a position in the mounting substrate 30 where the reflection mirror 26 is disposed in embodiment 8, hence the length of the two-dimensional optical scanning type video projection device can be further decreased. The other functional effects are the same as embodiment 1 described above.

### Embodiment 11

A two-dimensional optical scanning type video projection device of embodiment 11 of the present invention will be described with reference to FIG. 17, where the non-light condensing reflection mirror 25₂ of embodiment 9 is replaced with the light condensing reflection mirror 25₄, so that the condensing lens 25₁ is not needed. Here the shape and disposition of each reflection mirror are schematically illustrated, and for the actual shape, refer to embodiment 1 described above.

As illustrated in FIG. 17, in the two-dimensional optical scanning type projection device of embodiment 11 of the present invention, the light source module device substrate 11, on which the optical waveguide type multiplexer 12, including the three optical waveguide patterns 14 and the optical multiplexing unit, is disposed, is mounted on the mounting substrate 30. On the other hand, the two-dimensional optical scanning mirror device substrate 21, on which the piezoelectric drive type two-dimensional optical scanning mirror device 20, including the movable mirror 22, is disposed, is mounted on the ceiling portion of the cover member 31. For the optical waveguide type multiplexer 12, the optical waveguide type multiplexer disclosed in Patent Literature 3 is used.

In embodiment 11 of the present invention, the light condensing reflection mirror 25₄ is disposed to bend the emission multiplexed light beam 40, which is emitted from the optical waveguide type multiplexer 12, upward, and the emission multiplexed light beam 40 is emitted toward the movable mirror 22 by the light condensing reflection mirror 25₄. The emission multiplexed light beam 40 is reflected by the reflection mirror 26 disposed on the mounting substrate 30 after two-dimensionally scanned by the movable mirror 22, then emits through the window 32, and projects video onto a screen or a retina.

According to embodiment 11 of the present invention, the non-light condensing reflection mirror 25₂ of embodiment 9 is replaced with the light condensing reflection mirror 25₄, so that the condensing lens 25₁ is not needed, hence the length of the two-dimensional optical scanning type video projection device can be decreased. The other functional effects are the same as embodiment 1 and embodiment 9 described above.

### Embodiment 12

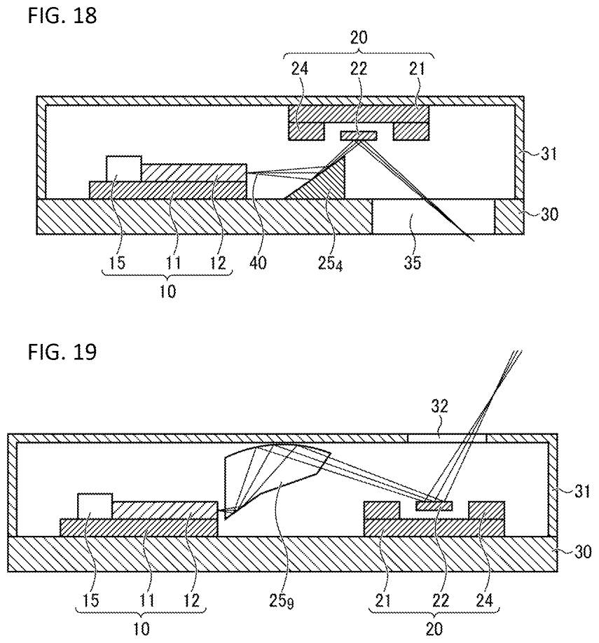

A two-dimensional optical scanning type video projection device of embodiment 12 of the present invention will be described with reference to FIG. 18, where the window 35 is provided in the mounting substrate 30 without providing the reflection mirror 26 of embodiment 11. FIG. 18 is a schematic configuration diagram of the two-dimensional optical scanning type video projection device of embodiment 11 of the present invention. Here the shape and disposition of each reflection mirror are schematically illustrated, and for the actual shape, refer to embodiment 1 described above.

As illustrated in FIG. 18, in the two-dimensional optical scanning type video projection device of embodiment 12 of the present invention, the light source module device substrate 11, on which the optical waveguide type multiplexer 12, including the three optical waveguide patterns 14 and the optical multiplexing unit, is disposed, is mounted on the mounting substrate 30. On the other hand, the two-dimensional optical scanning mirror device substrate 21, on which the piezoelectric drive type two-dimensional optical scanning mirror device 20, including the movable mirror 22, is disposed, is mounted on the ceiling portion of the cover member 31. For the optical waveguide type multiplexer 12, the optical waveguide type multiplexer disclosed in Patent Literature 3 is used.

In embodiment 12 of the present invention, the light condensing reflection mirror 25₄ is disposed to bend the emission multiplexed light beam 40, which is emitted from the optical waveguide type multiplexer 12, upward, and the emission multiplexed light beam 40, which was bended upward by the light condensing reflection mirror 25₄, is emitted toward the movable mirror 22. The emission multiplexed light beam 40 emits through the window 35 disposed in the mounting substrate 30 after two-dimensionally scanned by the movable mirror 22, and projects video onto a screen or a retina.

According to embodiment 12 of the present invention, the window 35 is provided at a position in the mounting substrate 30 where the reflection mirror 26 is provided in embodiment 10, hence the length of the two-dimensional optical scanning type video projection device can be further decreased. The other functional effects are the same as embodiment 1 and embodiment 9 described above.

### Embodiment 13

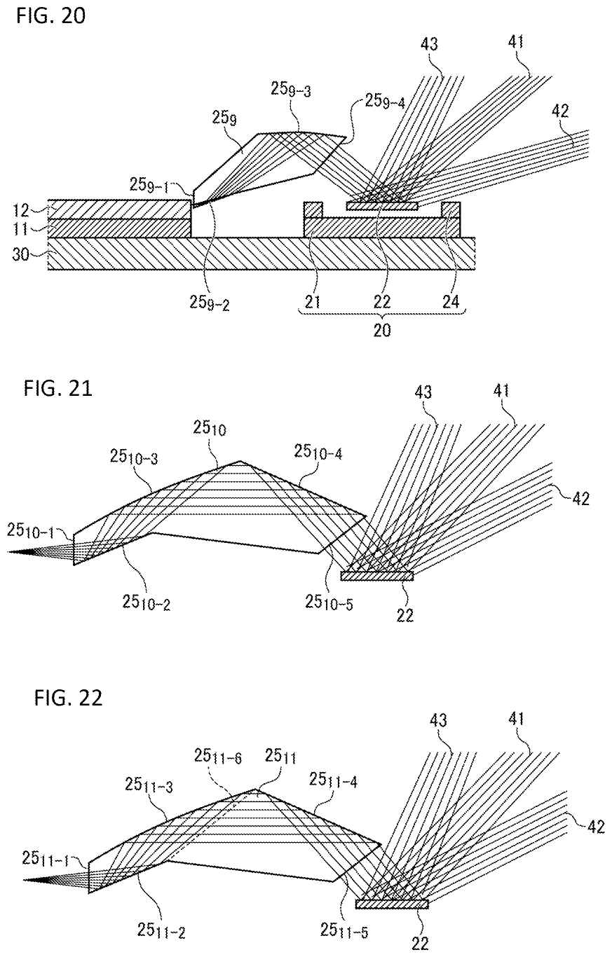

A two-dimensional optical scanning type video projection device of embodiment 13 of the present invention will be described with reference to FIG. 19 and FIG. 20, where the condensing lens of embodiment 5 is removed. FIG. 19 is a schematic configuration diagram of the two-dimensional optical scanning type video projection device of embodiment 13 of the present invention, and FIG. 20 is an explanatory diagram of a reflection state in the two-dimensional optical scanning type video projection device of embodiment 13 of the present invention. As illustrated in FIG. 20, the light beam that enters from an incident surface 25₉₋₁ to a prism 25₉ in which a light condensing reflection surface 25₉₋₃ is provided in an upper surface, is bended upward by a non-light condensing reflection surface 25₉₋₂. The light beam that was bended upward is reflected by a light condensing reflection surface 25₉₋₃, and is emitted through an emission surface 25₉₋₄ toward the movable mirror 22. The emitted emission multiplexed light beam emits through the window 32 after two-dimensionally scanned by the movable mirror 22, and projects video onto a screen or a retina.

Just like FIG. 11, the reflected light beam 41 indicates a case where the angle of the movable mirror is 0°, the reflected light beam 42 indicates a case where the angle of the movable mirror 22 is tilted by 12°, and the reflected light beam 43 indicates a case where the angle of the movable mirror 22 is tilted by 12° in the opposite direction. Here the prism 25₉ is fixed to the cover member 31, but may be fixed to the mounting substrate 30.

Here the incident surface 25₉₋₁ is a plane for the output light to enter the prism 25₉, or is a concave-curved surface, which has a surface perpendicular to each incident ray constituting the light beam at the incident position of this ray. If the incident surface 25₉₋₁ is a concave-curved surface that has a surface perpendicular to each incident ray at the incident position, the refractive angle does not differ depending on the wavelength of the incident light, hence the condensing characteristics do not depend on the wavelength.

The non-light condensing reflection surface 25₉₋₂ is a flat reflection surface to bend the radiated light toward the upper surface. It is preferable that the angle of the reflection surface is configured so that all of the incident rays constituting the light beam are totally reflected, but total reflection is not always necessary, and the incident light may be reflected by a reflection metal film, or the like, that is formed on the surface of the prism 25₉.

The light condensing reflection surface 25₉₋₃ is a light condensing reflection curved surface to condense the output light that is emitted in a spread out state from the optical waveguide type multiplexer 12, and preferably is an elliptical surface, but may be a surface that can condense the light, such as a curved surface approximated by a polynomial expression. This light condensing reflection curved surface as well preferably has an angle of the reflected surface by which total reflection is performed, but total reflection is not always needed, and the incident light may be reflected by a reflection metal film or the like that is formed on the surface of the prism 25₉.

The emission surface 25₉₋₄ is a plane for the light beam to emit from the prism, or a concave or convex curved surface, which has a surface perpendicular to each emitting ray at the emitting position of this ray. The other surfaces of the prism 25₉ may be any type of surface, but is normally a plane. The material of the prism 25₉ is SiO₂ glass, but may be any material which light transmits through, such as a transparent resin. In embodiment 13, there is one light condensing reflection surface, but two or more light condensing reflection surfaces may be used, and a number of reflection surfaces, including the non-light condensing reflection surfaces, may be further increased.

### Embodiment 14

A two-dimensional optical scanning type video projection device of embodiment 14 of the present invention will be described with reference to FIG. 21. Here only a key portion is illustrated, but a configuration other than a prism 25₁₀ is the same as embodiment 13. FIG. 21 is an explanatory diagram of the two-dimensional optical scanning type video projection device of embodiment 14 of the present invention, and the light beam that enters from an incident surface 25₁₀₋₁ to the prism 25₁₀ is bended upward by a non-light condensing reflection surface 25₁₀₋₂. The light beam which is bended upward is reflected by a light condensing reflection surface 25₁₀₋₃, is then reflected by a non-light condensing reflection surface 25₁₀₋₄, and is emitted through an emission surface 25₁₀₋₅ toward the movable mirror 22. After two-dimensionally scanned by the movable mirror 22, the emitted emission multiplexed light beam projects a video onto a screen or a retina.

In embodiment 14 of the present invention, a number of the non-light condensing reflection surfaces is increased by one, totaling three, whereby the light is reflected, hence the total size of the video projection device can be decreased. The configuration of each surface and material of the prism 25₁₀ are the same as embodiment 13 described above. The prism 25₁₀ may be fixed to the mounting substrate using an appropriate fixing member, or may be fixed to the cover member. In embodiment 14 too, two or more light condensing reflection surfaces may be used, and a number of the reflection surfaces, including the non-light condensing reflection surfaces, may be increased.

### Embodiment 15

A two-dimensional optical scanning type video projection device of embodiment 15 of the present invention will be described with reference to FIG. 22, where the configuration other than a prism 25₁₁ is the same as embodiment 14. FIG. 22 is an explanatory diagram of a key portion of the two-dimensional optical scanning type video projection device of embodiment 15 of the present invention, and the prism 25₁₁ is divided into two by the dividing plane 25₁₁₋₆, and the shape and the like are the same as the prism 25₁₀ of embodiment 14.

In embodiment 15 of the present invention, the prism 25₁₁ is divided, hence the prism 25₁₁ is easily manufactured. The prism 25₁₁ may be fixed to the mounting substrate using an appropriate fixing member, or may be fixed to the cover member. In embodiment 15 too, two or more light condensing reflection surfaces may be used, and a number of reflection surfaces, including the non-light condensing reflection surfaces, may be increased,

### Embodiment 16

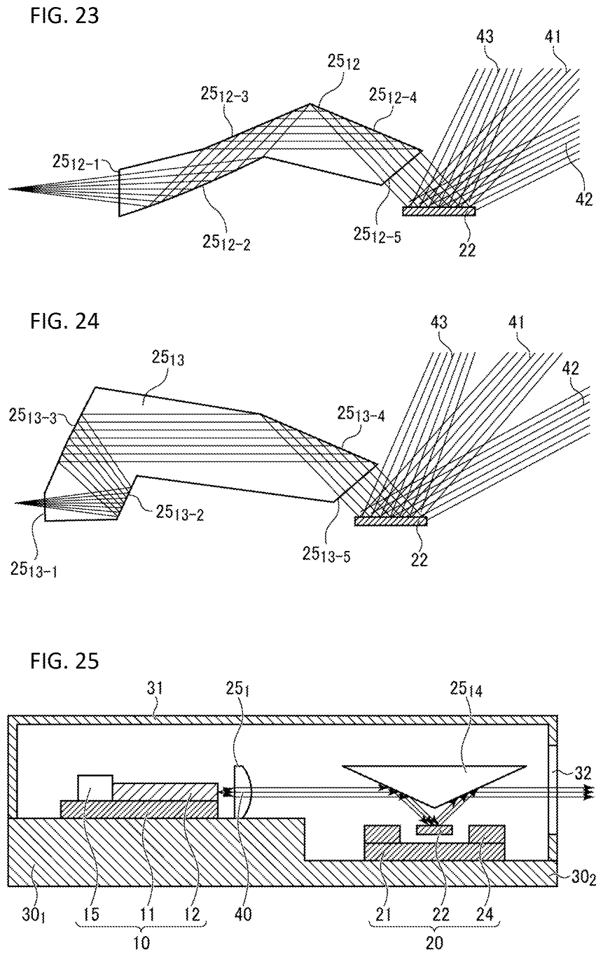

A two-dimensional optical scanning type video projection device of embodiment 16 of the present invention will be described with reference to FIG. 23, where the configuration other than a prism 25₁₂ is the same as embodiment 14. FIG. 23 is an explanatory diagram of a key portion of the two-dimensional optical scanning type video projection device of embodiment 16 of the present invention, and a light condensing reflection surface 25₁₂₋₂ is provided on the lower side of the prism 25₁₂, and the other surfaces of the prism 25₁₂ are constituted by non-light condensing reflection surfaces 25₁₂₋₃ and 25₁₂₋₄.

In embodiment 16 of the present invention too, the prism 25₁₂ may be divided in the same manner as embodiment 15. The prism 25₁₂ may be fixed to the mounting substrate using an appropriate fixing member, or may be fixed to the cover member. In embodiment 16 too, two or more light condensing reflection surfaces may be used, and a number of reflection surfaces, including the non-light condensing reflection surfaces, may be further increased.

### Embodiment 17

A two-dimensional optical scanning type video projection device of embodiment 17 of the present invention will be described with reference to FIG. 24, where the configuration other than a prism 25₁₃ is the same as embodiment 14. FIG. 24 is an explanatory diagram of a key portion of the two-dimensional optical scanning type video projection device of embodiment 17 of the present invention, and a light condensing reflection surface 25₁₃₋₃ is disposed in the prism 25₁₃, and the other surfaces of the prism 25₁₃ are constituted by non-light condensing reflection surfaces 25₁₃₋₂ and 25₁₃₋₄.

In embodiment 17 of the present invention, the light beam that enters the light condensing reflection surface 25₁₃₋₃ is closer to the vertical incidence compared with the embodiment 15 described above, hence even if the position of the light condensing reflection surface 25₁₃₋₃ deviates, the position of the light beam does not deviate very much. Further, even if positional deviation occurs when the prism is installed, the position of the light beam does not deviate very much, and beam shape does not change very much as well. The curved surface of the light condensing reflection surface 25₁₃₋₃ in this case is preferably an elliptical surface, but may be any curved surface if light can be condensed, such as a curved surface approximated by a polynomial expression.

The prism 25₁₃ may be fixed to the mounting substrate using an appropriate fixing member or may be fixed to the cover member. In embodiment 17 too, two or more light condensing reflection surfaces may be used, and a number of reflection surfaces, including the non-light condensing reflection surfaces, may be further increased. In embodiment 17 of the present invention too, the prism 25₁₃ may be divided in the same manner as embodiment 15.

### Embodiment 18

A two-dimensional optical scanning type video projection device of embodiment 18 of the present invention will be described with reference to FIG. 25, where the configuration is the same as embodiment 6, except that the light beam, after being reflected by the movable mirror 22 using a prism 25₁₄, is emitted in the horizontal direction with respect to the mounting substrate. FIG. 25 is a schematic configuration diagram of the two-dimensional optical scanning type video projection device of embodiment 18 of the present invention, where a triangular prism 25₁₄, of which two surfaces are non-light condensing reflection mirror surfaces, is used instead of the non-light condensing reflection mirror 25₇. Two flat type non-light condensing reflection mirrors may be disposed on the reflection surfaces, instead of the triangular prism 25₁₄.

The light beam after two-dimensionally scanned emits through the window 32, and the light beam in a state where the movable mirror 22 does not deflect, as illustrated, that is, in a state where the angle of the movable mirror 22 is 0°, becomes parallel with the upper mounting portion 30₁ and the lower mounting portion 30₂. Here even if the parallel output beams are not exactly parallel, the configuration of the triangular prism 25₁₄ can be used. The reflection light beam can be acquired most efficiently if parallelism is ±10°, but is acceptable if within an approximate ±45°. If one or two reflection surfaces of the triangular prism 25₁₄ are light condensing surfaces, then the condensing lens 25₁ is not needed.

In FIG. 25, illustration of the supporting and fixing jig of the prism 25₁₄ is omitted. In this description, the substrate has a step, but the step is not always needed as long as the light beam is not interrupted by the movable mirror. There is one cover member 31 here, but the cover member 31 may be divided into two, as illustrated in FIG. 13 of embodiment 7.

For the scanning direction of the light beam which is emitted in parallel with the substrate after reflection by the movable mirror 22, the direction parallel with the page surface in FIG. 25 may be a high-speed scanning direction or a low-speed scanning direction. In this description, the two-dimensional scanning mirror is used, but the same description is applicable to a one-dimensional scanning mirror.

### Embodiment 19

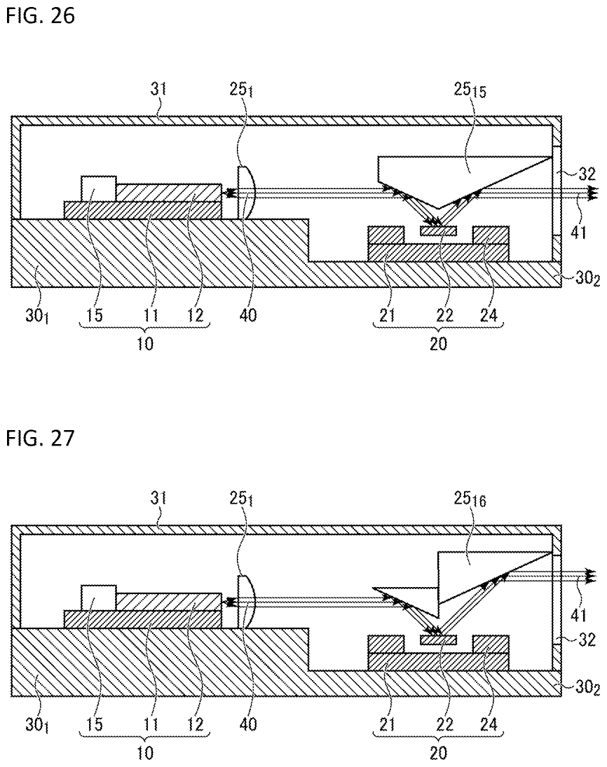

A two-dimensional optical scanning type video projection device of embodiment 19 of the present invention will be described with reference to FIG. 26, where a configuration other than the shape of a prism 25₁₅ is the same as embodiment 18. FIG. 26 is a schematic configuration diagram of the two-dimensional optical scanning type video projection device of embodiment 19 of the present invention, where the size of the incident side and the size of the emission side of the triangular prism 25₁₅, of which two surfaces are reflection mirror surfaces, are different, so that the movable mirror 22 can be scanned at a wider angle.

In FIG. 26, an illustration of a supporting and fixing jig of the prism 25₁₅ is omitted. In this description, the substrate has a step, but the step is not always needed as long as the light beam is not interrupted by the movable mirror 22. There is one cover member 31 here, but the cover member 31 may be divided into two, as illustrated in FIG. 13 of embodiment 7.

### Embodiment 20

A two-dimensional optical scanning type video projection device of embodiment 20 of the present invention will be described with reference to FIG. 27, where a configuration other than the different shape of a prism 25₁₆ is the same as embodiment 18. FIG. 27 is a schematic configuration diagram of the two-dimensional optical scanning type video projection device of embodiment 20 of the present invention, where a reflection member, combining two surface reflection type prisms, is used for the triangular prism 25₁₆ of which two surfaces are reflection mirror surfaces, and the height of the output multiplexed light beam 40 and the height of the reflected light beam 41 are different.

In FIG. 27, illustration of the supporting and fixing jig of the prism 25₁₆ is omitted. In this description, the substrate has a step, but the step is not always needed as long as the light beam is not interrupted by the movable mirror 22. There is one cover member 31 here, but the cover member 31 may be divided into two, as illustrated in FIG. 13 of embodiment 7.

### Embodiment 21

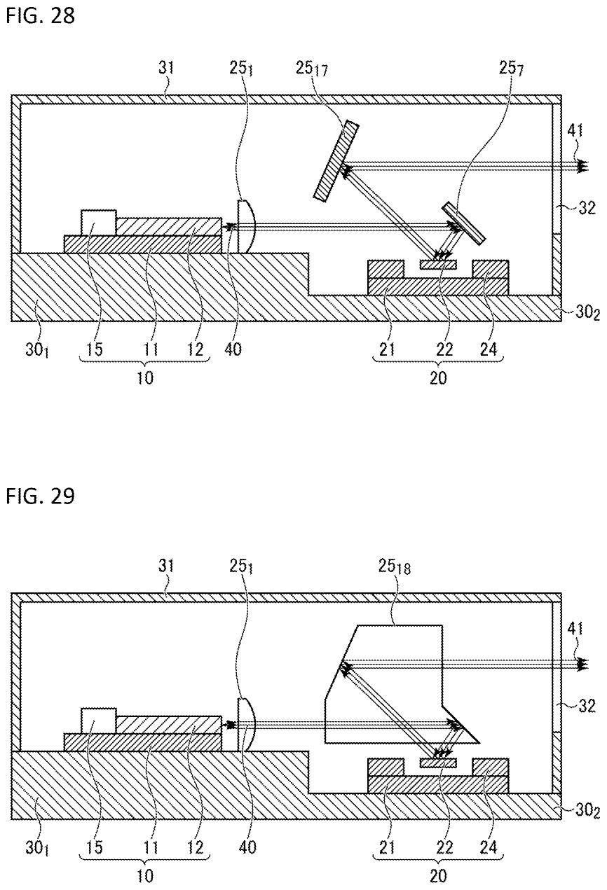

A two-dimensional optical scanning type video projection device of embodiment 21 of the present invention will be described with reference to FIG. 28, where the configuration is the same as embodiment 6, except that a non-light condensing reflection mirror 25₁₇ is separately disposed. FIG. 28 is a schematic configuration diagram of the two-dimensional optical scanning type video projection device of embodiment 21 of the present invention, where the non-light condensing reflection mirror 25₁₇ is separately disposed, so that the light beam 41 in a state where the movable mirror 22 does not deflect, that is, in a state where the angle of the movable mirror 22 is 0°, becomes parallel with the upper mounting portion 30₁ and the lower mounting portion 30₂.

In FIG. 28, illustration of the supporting and fixing jig of the non-light condensing reflection mirror 25₁₇ is omitted. In this description, the substrate has a step, but the step is not always needed as long as the light beam is not interrupted by the movable mirror 22. There is one cover member 31 here, but the cover member 31 may be divided into two, as illustrated in FIG. 13 of embodiment 7.

### Embodiment 22

A two-dimensional optical scanning type video projection device of embodiment 22 of the present invention will be described with reference to FIG. 29, where the configuration is the same as embodiment 6, except that a non-light condensing multi-surface internal reflection prism 25₁₈ is used. FIG. 29 is a schematic configuration diagram of the two-dimensional optical scanning type video projection device of embodiment 22 of the present invention, where the non-light condensing multi-surface internal reflection prism 25₁₈, which has the same reflection function as the two non-light condensing reflection mirrors 25₇ and 25₁₇ of embodiment 21, is used.

In FIG. 29, illustration of a supporting and fixing jig of the non-light condensing multi-surface internal reflection prism 25₁₈ is omitted. In this description, the substrate has a step, but the step is not always needed as long as the light beam is not interrupted by the movable mirror 22. There is one cover member 31 here, but the cover member 31 may be divided into two, as illustrated in FIG. 13 of embodiment 7.

### Embodiment 23

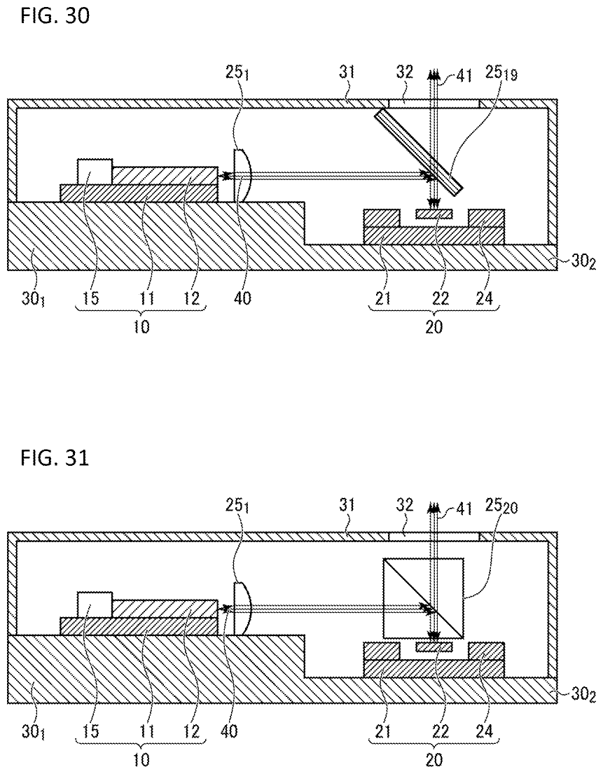

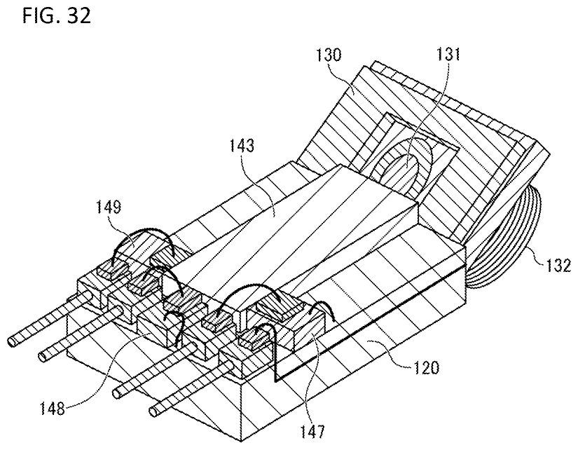

A two-dimensional optical scanning type video projection device of embodiment 23 of the present invention will be described with reference to FIG. 30, where the configuration is the same as embodiment 6, except that a semi-transparent mirror 25₁₉ is used. FIG. 30 is a schematic configuration diagram of the two-dimensional optical scanning type video projection device of embodiment 23 of the present invention, where the light beam 41, in a state where the movable mirror 22 is not deflected, that is, in the state where the angle of the movable mirror 22 is 0°, is extracted in the direction vertical to the upper mounting portion 30₁ and the lower mounting portion 30₂ by using the semi-transparent mirror 25₁₉.

In this case, the output multiplexed beam 40 from the optical waveguide type multiplexer 12 is reflected downward by the semi-transparent mirror 25₁₉, is then reflected upward by the movable mirror 22, and after passing through the semi-transparent mirror 25₁₉, the output multiplexed beam 40 emits as the reflected light beam 41 in the direction vertical to the lower mounting portion 30₂. The mirror used here is the semi-transparent mirror 25₁₉, hence a part of the light beam does not travel in the vertical direction as the reflected light beam 41, and becomes the light beam returning to the optical waveguide type multiplexer 12 and the light beam travelling in parallel with the upper mounting portion 30₁ and the lower mounting portion 30₂, which are light beams that cannot be used. This means that the intensity of the reflected light beam 41 decreases, but no problems occur unless the application demands strong light. Even in the case where the vertically outputted beam here is not an accurate vertical beam, this configuration including the semi-transparent mirror 25₁₉ can be used. The perpendicularity is preferably ±10°, since the reflected light beam 41 is acquired most efficiently, but may be within an approximate ±45°.

In FIG. 30, illustration of a supporting and fixing jig of the semi-transparent mirror 25₁₉ is omitted. In this description, the substrate has a step, but the step is not always needed as long as the light beam is not interrupted by the movable mirror 22. There is one cover member 31 here, but the cover member 31 may be divided into two, as illustrated in FIG. 13 of embodiment 7.

### Embodiment 24

A two-dimensional optical scanning type video projection device of embodiment 24 of the present invention will be described with reference to FIG. 31, where the configuration is approximately the same as embodiment 23, except that a prism type beam splitter 25₂₀ is used instead of the semi-transparent mirror 25₁₉. FIG. 31 is a schematic configuration diagram of the two-dimensional optical scanning type video projection device of embodiment 24 of the present invention, where the light beam 41, in a state where the movable mirror 22 does not deflect, that is, in the state where the angle of the movable mirror 22 is 0°, is extracted in the direction vertical to the upper mounting portion 30₁ and the lower mounting portion 30₂ by using the prism type beam splitter 25₂₀.

In this case too, a part of the light beam does not travel in the vertical direction as the reflected light beam 41, and becomes the light beam returning to the optical waveguide type multiplexer 12 and the light beam travelling in parallel with the upper mounting portion 30₁ and the lower mounting portion 30₂, which are light beams that cannot be used. This means that the intensity of the reflected light beam 41 decreases, but no problems occur unless the application demands strong light. Even in the case where the vertical output beam here is not an accurate vertical beam, this configuration including the prism type beam splitter 25₂₀ can be used. The perpendicularity is preferably ±10° since the reflected light beam 41 is acquired most efficiently, but may be within an approximate ±45°.

In FIG. 31, illustration of a supporting and fixing jig of the prism type beam splitter 25₂₀ is omitted. In this description, the substrate has a step, but the step is not always needed as long as the light beam is not interrupted by the movable mirror 22. There is one cover member 31 here, but the cover member 31 may be divided into two, as illustrated in FIG. 13 of embodiment 7. Further, in this description, the two-dimensional scanning mirror is used, but the same description is applicable to a one-dimensional scanning mirror, and embodiment 1 to embodiment 23 described above are also applicable to a one-dimensional scanning mirror. For the scanning direction of the light beam which is emitted after reflection by the movable mirror 22, the direction parallel with the page surface FIG. 31 may be a high-speed scanning direction or a low-speed scanning direction, and this is also the same in the case of embodiment 1 to embodiment 23.

### REFERENCE SIGNS LIST

10 Light source module device
11 Light source module device substrate
12 Optical waveguide type multiplexer
13 Optical waveguide forming layer
14, 14₁, 14₂, 14₃ Optical waveguide pattern
15 Light source element
15₁ Blue semiconductor laser
15₂ Green semiconductor laser
15₃ Red semiconductor laser
16₁, 16₂, 16₃ Pad
17₁, 17₂, 17₃, 17₄ Wire on substrate
18₁, 18₂, 18₃ Bonding wire
20 Two-dimensional optical scanning mirror device
21 Two-dimensional optical scanning mirror device substrate
22 Movable mirror
23 Rotation outer frame
24 Non-rotation outer frame
25 Optical member
25₁ Condensing lens
25₂ Non-light condensing reflection mirror
25₃ Non-light condensing reflection mirror
25₃₋₁, 25₃₋₂ Non-light condensing reflection mirror
25₄ Light condensing reflection mirror
25₅ Light condensing reflection mirror
25₆ Prism
25₇ Non-light condensing reflection mirror
25₈ Light condensing reflection mirror
25₉ Prism
25₉₋₁ Incident surface
25₉₋₂ Non-light condensing reflection surface
25₉₋₃ Light condensing reflection surface
25₉₋₄ Emission surface
25₁₀ Prism
25₁₀₋₁ Incident surface
25₁₀₋₂ Non-light condensing reflection surface
25₁₀₋₃ Light condensing reflection surface
25₁₀₋₄ Non-light condensing reflection surface
25₁₀₋₅ Emission surface
25₁₁ Prism
25₁₁₋₁ Incident surface
25₁₁₋₂ Non-light condensing reflection surface
25₁₁₋₃ Light condensing reflection surface
25₁₁₋₄ Non-light condensing reflection surface
25₁₁₋₅ Emission surface
25₁₁₋₆ Dividing plane
25₁₂ Prism
25₁₂₋₁ Incident surface
25₁₂₋₂ Light condensing reflection surface
25₁₂₋₃ Non-light condensing reflection surface
25₁₂₋₄ Non-light condensing reflection surface
25₁₂₋₅ Emission surface
25₁₃ Prism
25₁₃₋₁ Incident surface
25₁₃₋₂ Non-light condensing reflection surface
25₁₃₋₃ Light condensing reflection surface
25₁₃₋₄ Non-light condensing reflection surface
25₁₅₋₅ Emission surface
25₁₄ Prism
25₁₅ Prism
25₁₆ Prism
25₁₇ Non-light condensing reflection mirror
25₁₈ Non-light condensing multi-surface internal reflection prism
25₁₉ Semi-transparent mirror
25₂₀ Prism type beam splitter
26 Reflection mirror
30 Mounting substrate
30₁ Upper mounting portion
30₂ Lower mounting portion
31 Cover member
31₁ Light source module device cover member
31₂ Two-dimensional optical scanning mirror device cover member
32, 32, 33, 34₁, 34₂, 35 Window
36₁, 36₂, 36₃, 36₄ Pad
37₁, 37₂, 37₃, 37₄ Substrate wire
38₁, 38₂, 38₃, 38₄ Pad
39₁, 39₂, 39₃, 39₄ Bonding wire
40 Output multiplexed light beam
41, 42, 43 Reflected light beam
120, 121 Mounting substrate
130 Two-dimensional Optical scanning mirror device
131 Scanning mirror
132 Solenoid coil
140 Three primary color light source module device
143 Optical waveguide type multiplexer
147 Red semiconductor laser chip
148 Green semiconductor laser chip
149 Blue semiconductor laser chip

1. An optical scanning type video projection device comprising:
a light source module device having a first substrate on which a plurality of light source elements and an optical waveguide type multiplexer having a plurality of optical waveguides and an optical multiplexing unit are mounted, the optical waveguide type multiplexer having a plate shape, and lights from the plurality of light source elements entering in the plurality of optical waveguides respectively;
an optical scanning mirror device having a second substrate on which a non-rotation outer frame to which a movable mirror is provided is mounted;
a mounting substrate having an upper mounting portion and a lower mounting portion having a step therebetween, the first substrate being mounted on the upper mounting portion and the second substrate being mounted on the lower mounting portion respectively, and the first substrate and the second substrate being disposed in parallel with each other;
a light condensing device condensing a light beam emitted from the optical waveguide type multiplexer to emit condensed light beam along mount surfaces of the upper mounting portion and the lower mounting portion; and
an optical member having a reflection member to which the condensed light beam enters and which reflects the condensed light beam downward to the movable mirror, wherein
the movable mirror reflects the condensed light beam and is rotated for two-dimensionally scanning the reflected light beam by the movable mirror.

2. The optical scanning type video projection device according to claim 1, wherein
a main surface of the movable mirror is in parallel with a main surface of the second substrate in a non-operation state.

3. The optical scanning type video projection device according to claim 1, wherein
the optical scanning mirror device further has a rotation outer frame inside which the movable mirror is provided in rotatable in a first rotation direction, and
the rotation outer frame is provided inside the non-rotation outer frame in rotatable in a second rotation direction.

4. The optical scanning type video projection device according to claim 1, wherein the light condensing device includes a combination lens of a convex lens and a concave lens.

5. The optical scanning type video projection device according to claim 1, wherein
the reflection member is disposed at a opposite side to the light condensing device with respect to the movable mirror,
the reflected light beam is reflected upward to a direction of the light condensing device with respect to the movable mirror.

6. The optical scanning type video projection device according to claim 1, wherein
the reflection member includes a semi-transparent mirror disposed above the movable mirror, and
the semi-transparent mirror reflects the condensed light beam downward to the movable mirror, the movable mirror reflects the condensed light beam upward to the semi-transparent mirror, and the reflected light beam passes through the semi-transparent mirror.

7. The optical scanning type video projection device according to claim 1, wherein
the reflection member includes a prism type beam splitter disposed above the movable mirror, and
the prism type beam splitter reflects the condensed light beam downward to the movable mirror, the movable mirror reflects the condensed light beam upward to the prism type beam splitter, and the reflected light beam passes through the prism type beam splitter.

8. The optical scanning type video projection device according to claim 1, wherein
the optical member includes
a first reflection device having a first reflection mirror surface as the reflection member, and
a second reflection device having a second reflection mirror surface that reflects the reflected light beam reflected by the movable mirror toward a horizontal direction with respect to the mounting substrate,
a first height at which the reflected light beam is reflected from the second reflection mirror surface when a main surface of the movable mirror is in a horizontal position is higher than a second height at which the condensed light beam enters to the first reflection mirror surface.

9. An optical scanning type video projection device comprising:
a light source module device having a first substrate on which a plurality of light source elements and an optical waveguide type multiplexer having a plurality of optical waveguides and an optical multiplexing unit are mounted, the optical waveguide type multiplexer having a plate shape, and lights from the plurality of light source elements entering in the plurality of optical waveguides respectively;
an optical scanning mirror device having a second substrate on which a non-rotation outer frame to which a movable mirror is provided is mounted;
a mounting substrate on which the first substrate and the second substrate are mounted in parallel with each other;
a prism having a first reflection surface that bends a light beam emitted from the optical waveguide type multiplexer upward, a second reflection surface that reflects the light beam bended upward by the first reflection surface, and a third reflection surface that bends the light beam reflected by the second reflection surface downward to the movable mirror, wherein
at least one of the first reflection surface and the second reflection surface is a light condensing reflection surface, and
the movable mirror reflects the light beam bended by the third reflection surface and is rotated for two-dimensionally scanning the light beam reflected by the movable mirror.
